(19) United States
(12) Patent Application Publication
(10) Pub. No.: US 2018/0263251 A1
(43) Pub. Date: Sep. 20, 2018

(54) METHOD OF RAPIDLY AND UNIFORMLY THAWING FROZEN AGRICULTURAL AND MARINE PRODUCTS/PROCESSED FOODS

(71) Applicant: TOHOKU UNIVERSITY, Sendai-shi, Miyagi (JP)

(72) Inventors: Minoru SATO, Sendai-shi (JP); Toshiyasu YAMAGUCHI, Sendai-shi (JP); Toshiki NAKANO, Sendai-shi (JP)

(73) Assignee: TOHOKU UNIVERSITY, Sendai-shi, Miyagi (JP)

(21) Appl. No.: 15/760,773

(22) PCT Filed: Sep. 15, 2016
(86) PCT No.: PCT/JP2016/077334

§ 371 Date: Mar. 16, 2018

(30) Foreign Application Priority Data
Sep. 17, 2015 (JP) 2015-184304

(51) Int. Cl. A23B 4/07; A23L 3/365

(52) U.S. Cl. CPC A23B 4/07; A23L 3/365

(57) ABSTRACT

A rapid, uniform and high-quality thawing method is awaited which is free from a burn and boiling and which is indispensable for a freezing technology that is frequently used in the fishery industry and the fishery processing industry. For rapid thawing, electromagnetic waves of 130 to 300 MHz in which a B zone passage required time serving as a rate limiting step is decreased are utilized, for uniform thawing, electromagnetic waves of 110 to 170 MHz are utilized and in order to prevent boiling and a burn in the application and after the thawing, electromagnetic waves of 110 to 160 MHz in which a temperature increase after the thawing is decreased are utilized, with the result that the corresponding problems can be solved.

### TECHNICAL FIELD

The present invention relates to a technology that can be used as a method of rapidly and uniformly thawing frozen agricultural and marine products/processed foods, an example of which is mainly frozen fish meat, and that thaws agricultural and marine products/processed foods with electromagnetic waves of efficient frequencies in a rapid, uniform and high-quality manner.

### BACKGROUND ART

Although a frozen storage technology is a technology which makes it possible to store agricultural and marine products and processed foods for a long period of time while maintaining the freshness and quality thereof and which is an indispensable technology for modern society, an appropriate thawing technology for home and business use which is necessary for the utilization of the frozen storage technology is not found. All temperature changes when frozen products are thawed are in accordance with FIG. 1. The temperature changes are formed with three parts that are a part (A zone) whose temperature is increased from a storage freezing temperature so as to reach about −5° C., a part (B zone) which shows a gradual temperature change from −5° C. to −2° C. and a part (C zone) whose temperature is increased from about −2° C. to room temperature or a heating temperature. Among them, the B zone involves a dramatic phase conversion from ice (solid phase) to water (liquid phase) and is referred to as an ice crystal formation zone. The ice crystal formation zone causes the tissue destruction of food and leads to the occurrence of drips. Hence, not only a total thawing time but also the passage of the B zone in a short period of time leads to the maintenance of the quality of thawed foods. Variations in the temperature of the center portion and the surface at the time of thawing induce the boiling of the thawed product so as to lead to quality degradation, and thus a thawing method without causing temperature variations is required.

As examples of the method of thawing frozen products, there are classical thawing methods (referred to as “external heating methods” due to the utilization of the surrounding heat) such as a natural thawing method at room temperature or within a refrigerator and a flowing water thawing method, an electromagnetic wave thawing method (referred to as an “internal heating method” due to heating from the interior of an item to be thawed) which utilizes high-frequency waves around 13 MHz or microwaves around 2.5 GHz and the like. Non Patent Literature 1 lists, as requirements for a thawing method, (1) uniform thawing, (2) a thawing end temperature which is prevented from being excessively high, (3) a temperature increase to the thawing end temperature in a short period of time, (4) low drip loss at the time of thawing, (5) a small amount of drying in thawing, (6) a small amount of contamination in thawing, (7) no discoloration and the like.

Electromagnetic waves used in the thawing of Non Patent Literature 1 are assumed to include electromagnetic waves (around 13 MHz) of 11 to 40 MHz in a high-frequency band and electromagnetic waves (around 2.45 GHz) of 915 or 2,450 MHz in a microwave band. Patent Literature 1 adopts a method in which a device is incorporated that reads a high-frequency output produced when electromagnetic waves of 10 to 100 MHz are applied to a target and that makes an adjustment so as to keep it at an appropriate level, and in which thus the target is prevented from being partially overheated (boiled). In this background, it is assumed that the penetration into the target is deteriorated depending on the frequency and that thus overheating occurs only in the surface, and thus this device can be said to be unnecessary depending on the frequency used. In Patent Literature 2, a two-step thawing method is adopted in which a first step (dielectric heating step) is to apply electromagnetic waves of 1 to 100 MHz to a target and in which a second step (external heating step) is to subsequently apply a mist or a jet shower to the target from the outside so as to heat the target, and a complicated and large-scale device is needed. Patent Literature 3 discloses a method of applying electromagnetic waves of 10 to 300 MHz to a thawed target frozen by applying or mixing a cryoprotective substance such as sucrose so as to thaw the target, and it is impossible to use it for thawing marine products requiring fresh and delicate tastes. In Patent Literature 4, electromagnetic waves of 100±10 MHz are utilized. As problems in electromagnetic waves used for thawing, for example, around 13 MHz, the shapes of a target such as the size and the thickness and component compositions such as water are affected, and a “burn” is caused by a discharge which occurs as a result of application being performed between electrodes close to each other. Around 2.45 GHz, for example, “boiling” and non-uniform thawing in a surface are caused by the low penetration of electromagnetic waves. Although in 100±10 MHz, these problems seldom occur, full examinations are not performed on the reduction of a B zone passage time, the effect of decreasing variations in the temperature of the center portion and the surface and application conditions for achieving it.

As problems when electromagnetic waves are used for thawing, for example, around 13 MHz, the shapes of a target such as the size and the thickness and component compositions such as water are affected, and a “burn” is caused by a discharge which occurs as a result of application being performed between electrodes close to each other. Around 2.45 GHz, for example, “boiling” and non-uniform thawing in a surface are caused by the low penetration of electromagnetic waves. At present, the electromagnetic wave utilization thawing method cannot provide a thawed state where all the freshness and quality required for frozen products after being thawed are satisfied. Even in the range of 100 to 300 MHz, although the problems around 13 MHz and around the 2.45 GHz described above can be partially solved, there is no example where optimum application conditions or an optimum application method for achieving the effect of reducing the B zone passage time and producing no temperature difference between the surface and the center portion are specifically examined, with the result that the unsolved problems are still left.

### CITATION LIST

### Patent Literature

Patent Literature 1: Japanese Unexamined Patent Application Publication No. 57-68775
Patent Literature 2: Japanese Unexamined Patent Application Publication No. 2000262263
Patent Literature 3: Japanese Unexamined Patent Application Publication No. 2002-272436
Patent Literature 4: International Publication No. 2015/16171

### Non Patent Literature

Non Patent Literature 1: Hideo Tsuyuki, “About commercial high-frequency thawing machines/microwave thawing machines”, cold chain, 3 (1), 2-15 (1977)

### SUMMARY OF INVENTION

With respect to the electromagnetic waves of surrounding frequencies including the frequency of 100 MHz for thawing used in Patent Literature 4, a total thawing time, in particular, a B zone passage required time, a temperature difference between the center portion and the surface, a temperature increase rate after the completion of thawing and the like are examined, and thus the frequencies of electromagnetic waves having the optimum thawing ability are clarified and proposed.

### Technical Problem

Since ancient times, in Japan, the culture of eating marine products raw has widely taken root, and eating sashimi, sushi and the like is still widely favored. This affects the formation of a food culture in which consumers evaluate, purchase and eat thawed products with substantially the same strict standards as for fresh marine products and fresh marine processed products. Hence, in the fishery industry and the fishery processing industry, the use of the conventional thawing method which can cause quality degradation such as food poisoning resulting from a large number of drips, discoloration or microbial contamination or overheating is a critical problem to be solved that directly lowers business performance, and the creation of a better thawing technology is awaited.

An object of the present invention is to provide electromagnetic waves for thawing that can reduce a total thawing time which significantly affects the quality of thawed products, in particular, a B zone passage time serving as a rate limiting step, that can prevent variations in the temperature of the center portion and the surface which leads to the boiling or the drying of the surface at the time of thawing and that can decrease a rapid temperature increase after thawing (−2° C. or more) which leads to a burn or a deformation in thawed foods.

### Solution to Problem

In order to make the electromagnetic wave thawing an excellent thawing method, the frequencies of electromagnetic waves which satisfy the following requirements are clarified. One of the requirements is to be able to perform thawing while reducing a thawing time necessary for good-quality thawing, in particular, a B zone passage required time. The second is to reduce a temperature difference between the center portion and the surface which is necessary for preventing boiling and a burn in thawing, and this is also required for ensuring an automatic operation/automatic stop technology using a surface temperature sensor fitted to an automatic thawing machine. The third is to decrease a rapid temperature increase after thawing (−2° C. or more) so as to prevent final boiling. It is considered that electromagnetic waves satisfying these requirements are used such that an electromagnetic wave thawing machine for performing quick thawing while maintaining quality is substantially realized.

### Advantageous Effects of Invention

Disadvantageously, in the conventional classical thawing technology, it takes a long thawing time to thaw frozen foods, and drips occur after thawing. Although various thawing methods using electromagnetic waves are proposed, boiling and a burn in the thawing, the occurrence of drips, discoloration and the like are disadvantageous. This is because of the length of a thawing time, in particular, of a B zone passage time, variations in the temperature of the center and the surface of thawed products, a rapid temperature increase after thawing (−2° C. or more) and the like. Although the electromagnetic waves of 100±10 MHz utilized in Patent Literature 4 are an excellent frequency band, the information thereof is not sufficient. In the present invention, as electromagnetic waves having excellent properties on a thawing rate, in particular, a B zone passage rate, variations in the temperature of the center portion and the surface, a rapid temperature increase after thawing (−2° C. or more) and the like, electromagnetic waves in the band of 130 to 150 MHz are proposed. It is considered that by use of such electromagnetic waves, it is possible to establish an extremely excellent rapid and uniform thawing method.

### BRIEF DESCRIPTION OF DRAWINGS

FIG. 1 is an illustrative diagram of terms used in the present application document, and is a diagram illustrating temperature changes of frozen products when they are thawed with electromagnetic waves and the temperature variation zones of an A zone (frozen storage temperature to −5° C.), a B zone (−5° C. to −2° C.) and a C zone (−2° C. to room temperature);

FIG. 2 is a diagram showing temperature changes (thawing curves) in the center portion when a tuna block (5 cm×5 cm×4 cm, about 90 g) stored at −50° C. was thawed with electromagnetic waves of 60 MH, 100 MHz, 140 MHz, 170 MHz and 300 MHz;

FIG. 3 is a diagram showing times necessary for thawing (until −2° C. was reached) when the frozen tuna block was thawed with the electromagnetic waves of 100 to 170 MHz;

FIG. 4 is a diagram showing an A zone (−50° C. to −5° C.) passage required time in the thawing required time of FIG. 3;

FIG. 5 is a diagram showing a B zone (−5° C. to −2° C.) passage required time in the thawing required time of FIG. 3;

FIG. 6 is a diagram showing thawing curves in the 13 zone (−5° C. to −2° C.) when the frozen tuna block was thawed with the electromagnetic waves of 100 to 170 MHz;

FIG. 7 is a diagram showing thawing temperatures measured with an optical fiber thermometer which was inserted to a depth of 2.5 cm in the center portion (2.5 cm from the surface) and the surface (0.5 cm from the surface) of the frozen tuna block when the froze′ tuna block was thawed with the electromagnetic waves of 100 to 170 MHz; and

FIG. 8 is a diagram showing a C zone (−2° C. to 20° C.) passage required time when the frozen tuna block was thawed with the electromagnetic waves of 60 to 300 MHz and then the electromagnetic waves were continuously applied.

### DESCRIPTION OF EMBODIMENTS

An embodiment of the present invention will be described below with reference to drawings.

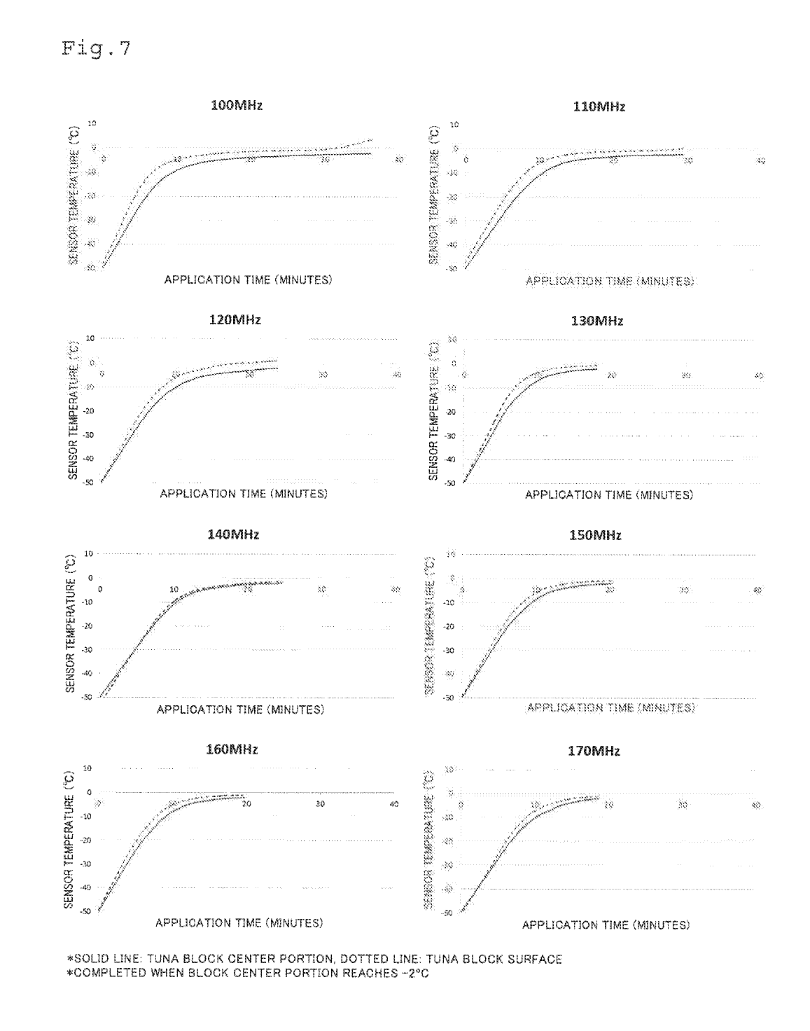

FIG. 1 shows temperature changes (thawing curve) when frozen products are thawed. All the frozen products are thawed in accordance with such a thawing curve. The temperature changes are formed with three parts that are a part (A zone) whose temperature is increased from a storage freezing temperature so as to reach about −5° C., a part (B zone) which shows a gradual temperature change from −5° C. to −2° C. and a part (C zone) whose temperature is increased from about −2° C. to room temperature or a heating temperature. It is found that it takes a long time to pass the B zone (−5° C. to −2° C.) and that the product temperature is slowly increased while the temperature is being repeatedly varied as shown in FIG. 6. Here, the tissue destruction of the frozen product is assumed to occur, and thus it is preferable to provide a thawing method in which the B zone is rapidly passed.

### Example 1

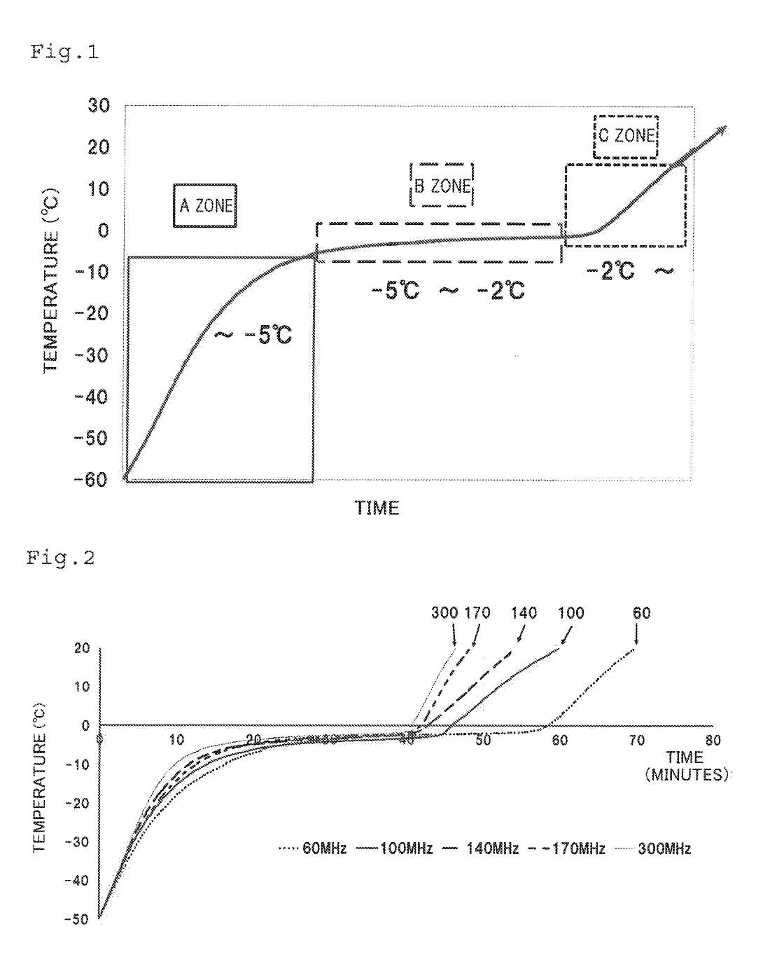

FIG. 2 is a diagram showing temperature changes (thawing curves) in the center portion when a frozen tuna block (5 cm×5 cm×4 cm, about 90 g) was thawed with electromagnetic waves of 60 MH, 100 MHz, 140 MHz, 170 MHz and 300 MHz. The thawing using the electromagnetic waves was performed by prototyping the thawing device disclosed in Patent Literature 4. The output of the electromagnetic waves was set to 25 W, and the electromagnetic waves were applied without the frequency and the output of the electromagnetic waves being changed until the completion of the thawing. The temperature was measured with an optical fiber thermometer (made by ASTECH Corporation) which was inserted to a depth of 2.5 cm in the center portion (2.5 cm from the surface) of the frozen tuna block. In the thawing at 100 MHz disclosed in Patent Literature 4, it takes 20 minutes or more to pass the B zone. It is clear from this information that as compared with the thawing at 60 MHz, the thawing at 100 MH is excellent but this needs to be improved as compared with 140 MHz, 170 MHz and 300 MHz. On the other hand, it is also clear that when electromagnetic waves of 140 MHz or more are adopted, the degree of a rapid temperature increase in the C zone is increased, and thus the risk for boiling is high as compared with 100 MHz. Hence, it is found that it is important to perform thawing at appropriate electromagnetic waves.

### Example 2

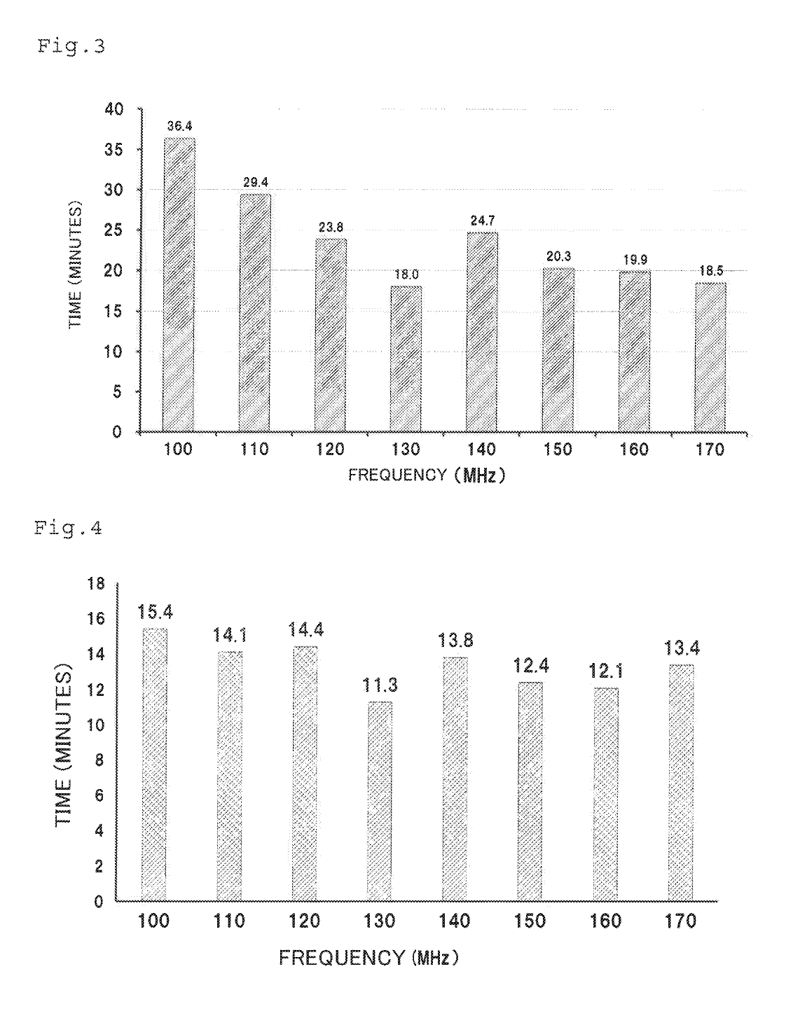

FIG. 3 is a diagram showing times necessary for thawing (until −2° C. was reached) when the frozen tuna block was thawed with the electromagnetic waves whose frequencies were changed from 100 to 170 MHz at intervals of 10 MHz. The conditions other than the frequencies used were the same as in Example 1. As shown in FIG. 3, it was found that the thawing time was minimized at 130 MHz and that almost no difference was produced in the thawing time up to 170 MHz. Hence, it was found that in the present example, the application frequencies were preferably ranged from 130 to 170 MHz.

### Example 3

FIG. 4 is a diagram showing times necessary for the center portion of the tuna block to pass the A zone (−50° C. to −5° C.) when the frozen tuna block was thawed with the electromagnetic waves whose frequencies were changed from 100 to 170 MHz at intervals of 10 MHz. The performance conditions were the same as in Example 2. As shown in FIG. 4, it was found that almost no difference was produced in an A zone passage required time in a range from 100 to 170 MHz, and it was suggested that the total thawing time significantly depended on a B zone passage required time. This result means that the storage of frozen products in a freezer is not necessarily stable and safe storage, and suggests a possibility that an automatic defrosting operation repeated in the freezer causes a considerable instability factor.

### Example 4

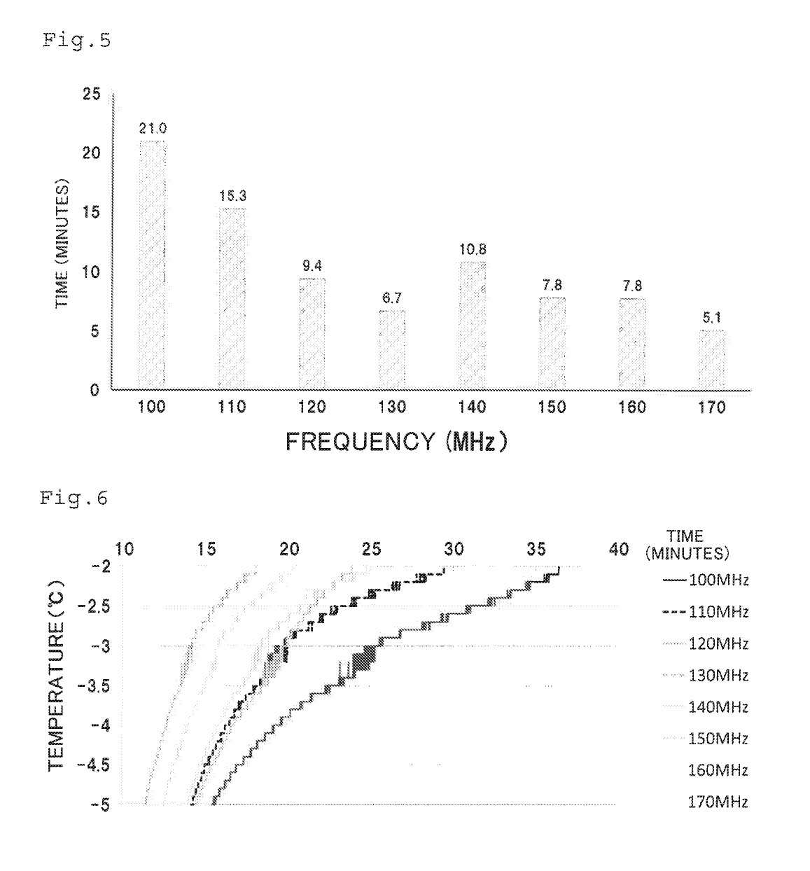

FIG. 5 is a diagram showing times necessary for the center portion of the tuna block to pass the B zone when the frozen tuna block was thawed with the electromagnetic waves whose frequencies were changed from 100 to 170 MHz at intervals of 10 MHz. The performance conditions were the same as in Examples 2 and 3. As shown in FIG. 5, it was found that the thawing time was maximized at 100 MHz used in Patent Literature 4, that the thawing time was minimized at 130 MHz and that almost no difference was produced in the thawing time up to 170 MHz. Since the tendencies of variations in the thawing time for the individual frequencies shown in FIGS. 3 and 5 coincided with each other, it was confirmed again in the present example that the contribution of the B zone passage required time to the total thawing time suggested in Example 3 was significant. It was also made clear from a close examination of data in Example 2 and the present example that at 170 MHz, 27% of the total thawing time was occupied by the B zone and that at 100 MHz, 58% thereof was occupied. Hence, in the present example, as in the result of Example 2, it was confirmed that the application frequencies ranging from 130 to 170 MHz were appropriate for the thawing.

FIG. 6 is the detailed plots (thawing curves) of variations in the temperature of the center of the tuna Hock at the time of the B zone passage at the individual frequencies in Example 4. Even when any frequency was selected, there was a time zone where the temperature was varied between −3.5° C. and −3.0° C., and it was shown that in the meantime, the melting and re-freezing of ice progressed. It is considered that as the time zone was shorter, the quality after the thawing was more satisfactorily kept. Even when the thawing curves were evaluated based on this viewpoint, as in the evaluation based on FIG. 5, it was confirmed that the application frequencies ranging from 130 to 170 MHz were appropriate for the thawing.

### Example 5

FIG. 7 shows thawing temperatures measured with the optical fiber thermometer (made by ASTECH Corporation) which was inserted to a depth of 2.5 cm in the center portion (2.5 cm from the surface) and the surface (0.5 cm from the surface) of the tuna block when the frozen tuna block was thawed with the electromagnetic waves whose frequencies ranged from 100 to 170 MHz. The other thawing conditions (the size of the frozen tuna block and the frequencies and the output) were the same as in the examples described above. In the thawing, a temperature difference between the surface and the center portion contributes to boiling after the thawing of frozen products, and thus it is possible to evaluate that conditions in which the temperature difference is smaller are more excellent conditions. As shown in FIG. 7, the thawing in which the temperature difference between the surface and the center portion was minimized was the thawing performed by the application of electromagnetic waves whose frequency was 140 MHz. The tendency that as the frequencies were lower or higher than 140 MHz, the temperature difference between the surface and the center portion increased was observed. It was made clear from the overall evaluation of the results of Example 4 and the present example that the electromagnetic waves in an electromagnetic wave band from 130 to 150 MHz were appropriate for uniform thawing and rapid thawing.

### Example 6

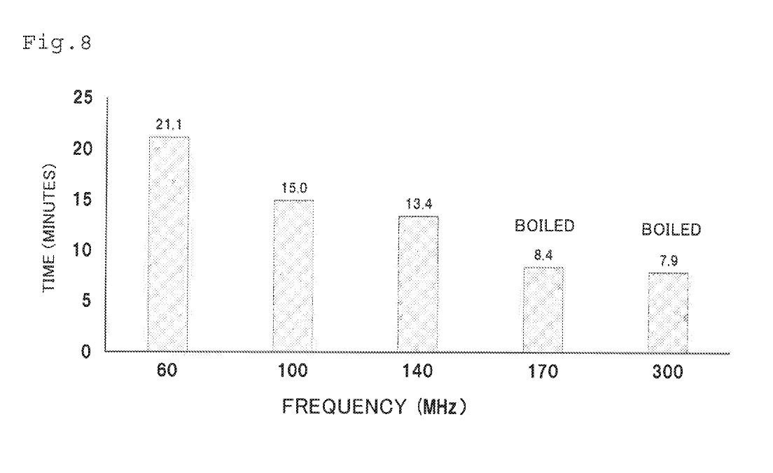

FIG. 8 shows results obtained by measuring times required for the center portion of the tuna block to pass the C zone (from −2° C. to 20° C.) when the frozen tuna block was thawed with the electromagnetic waves whose frequencies were 60 MHz, 100 MHz, 140 MHz, 170 MHz and 300 MHz. The other performance conditions were the same as in Example 1. As shown in FIG. 8, at 170 MHz and 300 MHz where the C zone passage required time was short, a burn and boiling occurred in the margin portion of the tuna. Hence, with consideration given to influences in the C zone, it was suggested that it was not appropriate to select the thawing using the electromagnetic waves of 170 MHz or more as frequencies for the thawing in the A zone and the B zone. With consideration given to the results of the examination in the present example and the results of the examination in Examples 4 and 5, it was confirmed that the frequency band appropriate for the thawing was the range from 130 to 150 MHz.

Since in Example 3 and FIG. 4, the passage required time in the A zone passage was little affected by the frequency selection, the following aspects of the thawing method are effective for performing appropriate thawing. One aspect is to select an arbitrary frequency in the thawing for the A zone passage and then select a frequency in the range from 130 to 150 MHz in a stage where the A zone is transferred to the B zone. The other aspect is to apply the electromagnetic waves of a frequency in the range from 130 to 150 MHz continuously from the A zone to the B zone in order to maximize the effect in the B zone. In the former aspect, the application in the A zone may be performed within the same application device as that for performing the application in the B zone or another application device may be used to perform the thawing in the A zone.

Based on the examples of the present invention where the temperature changes of the frozen foods in the C zone were observed, in the C zone, the selection of a frequency equal to or more than 170 MHz is not appropriate for pursuing satisfactory thawing quality. Here, with consideration given to the results of the examination in the B zone, it is preferable to also select a frequency for the C zone from the range from 130 to 150 MHz selected for the B zone. Preferably, when the same frequency is used both for the B zone and the C zone, the thawing from the B zone to the C zone is continuously performed with the same application device.

### INDUSTRIAL APPLICABILITY

The present invention provides, instead of a thawing method using the electromagnetic waves of 100±10 MHz proposed as a method of thawing frozen agricultural and marine products/processed foods, a technology which is a more rapid, good-quality thawing method without variations in temperature and which can be utilized not only in a fishery industry dealing with frozen products but also in various industries and homes. Since the present invention focuses on the time passage for thawing frozen products, the present invention can be applied in general to the thawing of other foods such as frozen meat, frozen vegetables, frozen seasoning processed foods and other frozen products.

1. A method of thawing a frozen food,
wherein electromagnetic waves of 110 to 300 MHz are applied to the frozen food.

2. A method of thawing a frozen food,
wherein electromagnetic waves of 130 to 170 MHz are applied to the frozen food.

3. A method of thawing a frozen food,
wherein electromagnetic waves of 130 to 150 MHz are applied to the frozen food.

4. A method of thawing a frozen food,
wherein in the thawing of the frozen food, thawing in a B zone (in which a temperature of a center of the frozen food ranges from −5° C. to −2° C.) is performed by application of electromagnetic waves of 130 to 150 MHz.

5. A method of thawing a frozen food,
wherein in the thawing of the frozen food, thawing in a B zone (in which a temperature of a center of the frozen food ranges from −5° C. to −2° C.) and thawing in a C zone (in which the temperature of the center of the frozen food ranges from −2° C. to room temperature) are performed by application of electromagnetic waves of 1.30 to 150 MHz.
